(19) United States
(12) Patent Application Publication
(10) Pub. No.: US 2010/0239420 A1
(43) Pub. Date: Sep. 23, 2010

(54) HYDRO-POWER PLANT

(76) Inventors: Koo Shik Lee, Seoul (KR); Dae Hoon Lee, Seoul (KR)

Correspondence Address: BACON & THOMAS, PLLC, 625 SLATERS LANE, FOURTH FLOOR, ALEXANDRIA, VA, 22314-1176, US

(21) Appl. No.: 12/450,154

(22) PCT Filed: Mar. 3, 2008
(86) PCT No.: PCT/KR2008/001210

§ 371 Date: Sep. 14, 2009

(30) Foreign Application Priority Data
Mar. 20, 2007 (KR) 10-2007-0026938

(51) Int. Cl. F03B 9/00; F03B 13/00

(52) U.S. Cl. 416/7

(57) ABSTRACT

Disclosed is a power generating system utilizing hydraulic force, and, more particularly, is a hydraulic power generating system, in which a plurality of water receiving plates are mounted on an elongated looped rail floating on the surface of water, thereby allowing the looped rail to be rotated by hydraulic force. To solve a conventional problem in that each of the water receiving plates on the looped rail receives a deteriorated hydraulic force due to the presence of a preceding water receiving plate and results in low use efficiency of hydraulic force, the looped rail is obliquely installed with respect to a water flow direction by an angle of 10 to 45 degrees, and the water receiving plates are installed at a right angle to the water flow direction. With this arrangement, each water receiving plate can receive a predetermined hydraulic force without deterioration of the hydraulic force due to the presence of a preceding water receiving plate, and consequently, the hydraulic power generating system can achieve improved hydraulic power generation efficiency.

### TECHNICAL FIELD

The present invention relates to a power generating system utilizing hydraulic force, and, more particularly, to a hydraulic power generating system, in which a plurality of water receiving plates are mounted on an elongated looped rail floating on the surface of water, thereby allowing pulleys on the looped rail to be rotated by hydraulic force.

### BACKGROUND ART

A conventional hydraulic power generating system is configured in such a way that a plurality of pulleys are mounted on an elongated looped rail floating on the surface of water and in turn, a plurality of water receiving plates are installed to the respective pulleys, thereby achieving rotation of the pulleys using hydraulic force. The above-described conventional hydraulic power generating system, however, has a disadvantage in that each of the water receiving plates, installed to the respective pulleys, receives a deteriorated hydraulic force due to the presence of a preceding water receiving plate, resulting in low use efficiency of hydraulic force.

### DISCLOSURE

### Technical Problem

Therefore, the present invention has been made in view of the above problems, and it is an object of the present invention to provide a hydraulic power generating system, wherein a plurality of water receiving plates are installed, respectively, to a plurality of pulleys mounted on a looped rail, and the looped rail extends obliquely with respect to a water flow direction by an angle of 10 to 45 degrees, whereby each water receiving plate can receive a predetermined hydraulic force without deterioration of the hydraulic force due to the presence of a preceding water receiving plate, and consequently, the hydraulic power generating system can achieve improved hydraulic power generation efficiency.

### DESCRIPTION OF DRAWINGS

The above and other objects, features and other advantages of the present invention will be more clearly understood from the following detailed description taken in conjunction with the accompanying drawings, in which:

FIG. 1 is a plan view illustrating important parts of a hydraulic power generating system according to an exemplary embodiment of the present invention;

FIG. 2 is a plan view illustrating an alternative embodiment of the hydraulic power generating system according to the present invention;

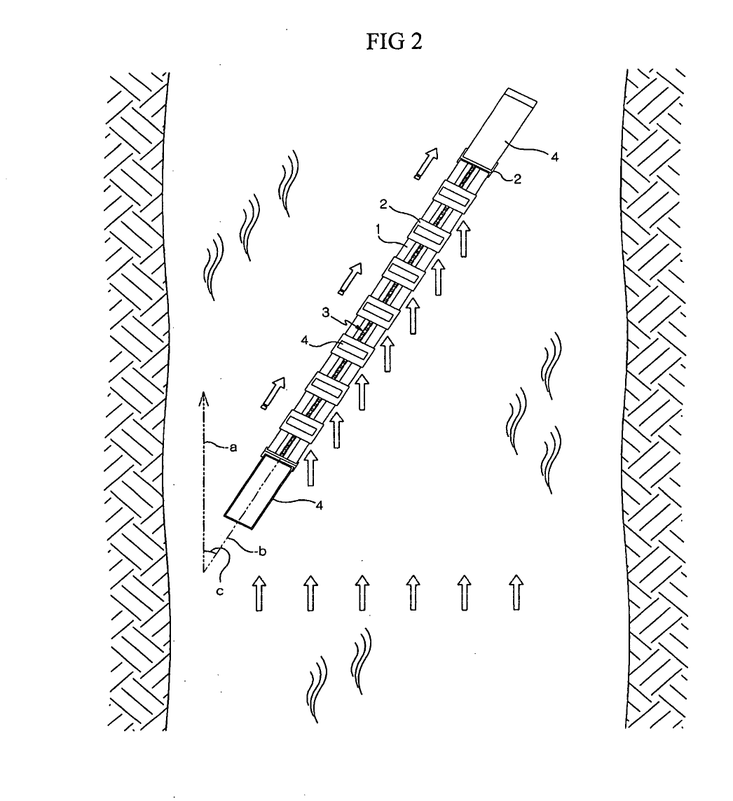

FIG. 3 is a perspective view illustrating important parts of the hydraulic power generating system according to the present invention; and

FIG. 4 is a partially cut-away perspective view illustrating a connector according to an exemplary embodiment of the present invention.

### BEST MODE

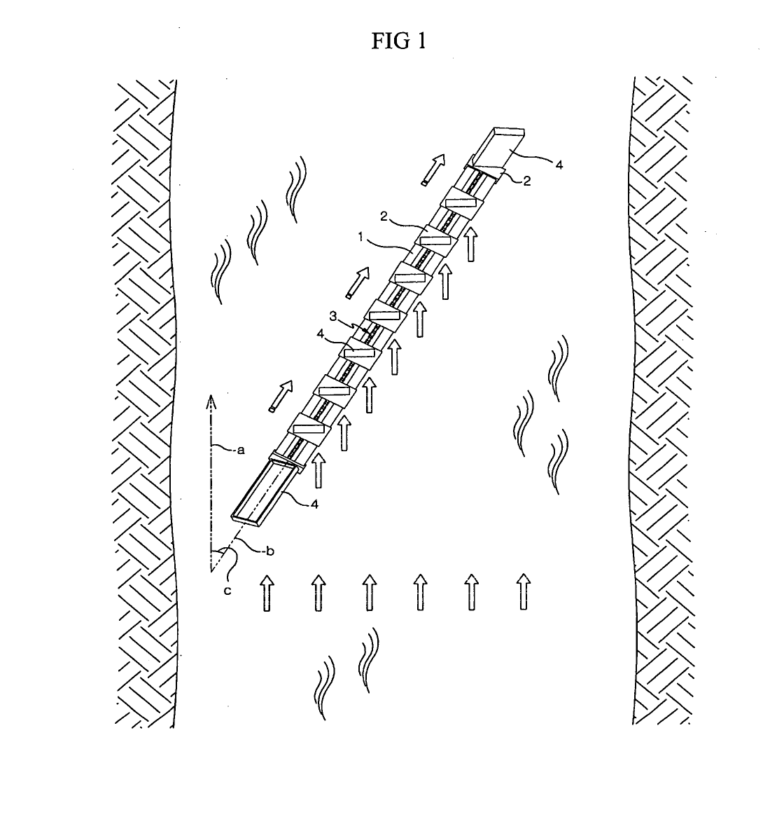

Referring to the drawings illustrating a hydraulic power generating system according to the present invention, the hydraulic power generating system basically includes a looped rail 1, a plurality of pulleys 2 mounted on the looped rail 1, a plurality of water receiving plates 4 each installed to each of the pulleys 2, and a plurality of connectors 3 used to connect the respective neighboring pulleys 2 with one another. The present invention, as shown in FIG. 1, has a feature in that the looped rail 1 is installed obliquely with respect to a water flow direction such that an installation direction of the looped rail 1, designated by the dot-dot dashed line “b”, and the water flow direction, designated by the dot-dot dashed line “a”, have an angle “c” of 10 to 45 degrees, preferably, of 30 degrees.

Preferably, the respective water receiving plates 4 installed to the pulleys 2 have a right angle with respect to the water flow direction “a”. Also, the respective water receiving plates 4 are preferably installed at a right angle to the looped rail installation direction “b”. In the latter case, in particular, there are several advantages, namely, allowing a hydraulic force applied to the water receiving plates 4 to act in the looped rail installation direction “b”, and reducing load on the pulleys 2 mounted on the looped rail 1.

Accordingly, the present invention provides a technology of limiting an installation angle of the water receiving plates 4 within a predetermined range from a direction perpendicular to the water flow direction “a” to a direction perpendicular to the looped-rail installation direction “b”.

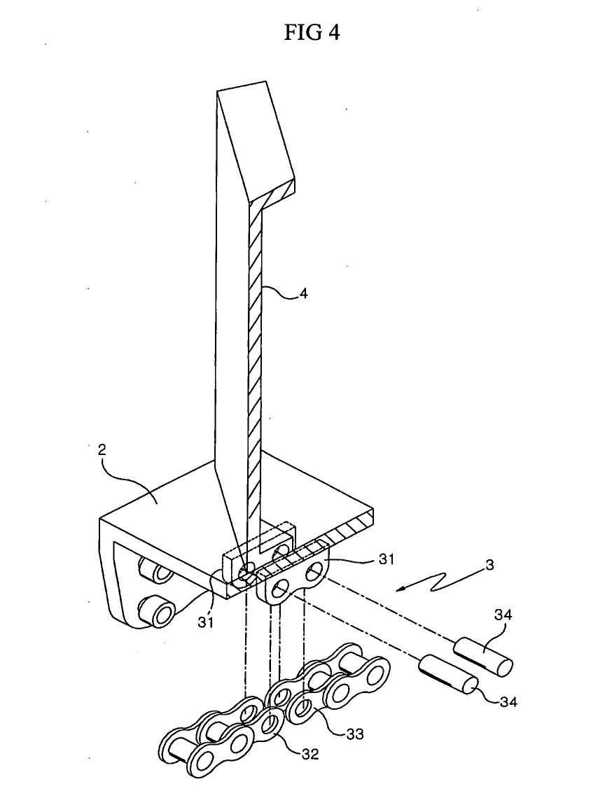

Moreover, the present invention provides a technology of using the chain-shaped connectors 3 provided to connect the respective neighboring pulleys 2 with one another. More specifically, as shown in FIG. 4, an attachment piece 31, having shaft holes, is provided at each of the pulleys 2. Also, adjacent ends 32 and 33 of two connectors 3 are aligned in a line such that shaft holes formed in both the ends 32 and 33 coincide with the shaft holes of the attachment piece 31. As shafts 34 are inserted through the corresponding shaft holes of the attachment piece 31 and both the ends 32 and 33, the pulleys 2 can be connected with one another by means of the connectors 3.

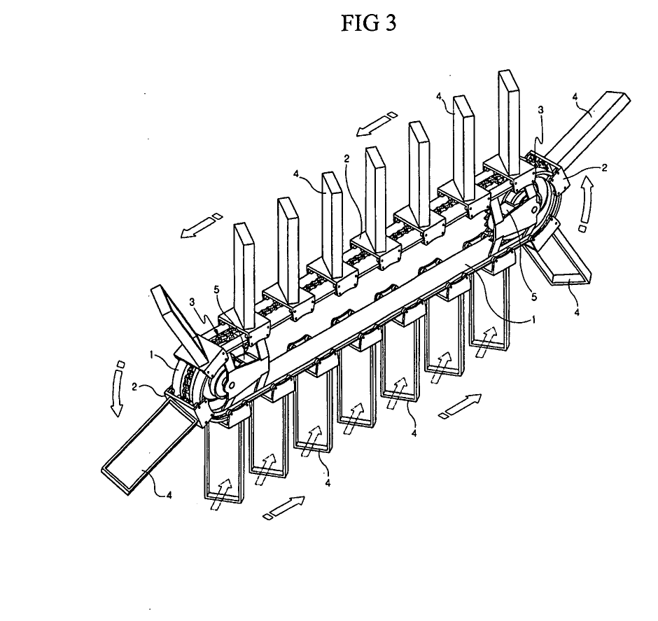

Referring to FIG. 3, generators 5 are installed at sprockets provided at both sides of the looped rail 1.

As apparent from the above description, according to the present invention, a looped rail, on which a plurality of water receiving plates are arranged, extends obliquely with respect to a water flow direction by an angle of 10 to 45 degrees. With this configuration, the water receiving plates can be arranged, rather than being arranged in a straight line with respect to the water flow direction, such that each water receiving plate is located beside a preceding water receiving plate along the water flow direction. This has the effect of preventing the respective water receiving plates from receiving deteriorated hydraulic force due to the presence of a preceding water receiving plate, and consequently, maximizing hydraulic force use efficiency.

Further, according to the present invention, the water receiving plates, installed to pulleys, have an installation angle within a predetermined range from a direction perpendicular to the water flow direction to a direction perpendicular to a looped-rail installation direction. As a result, the water receiving plates can be arranged substantially perpendicular to the water flow direction, and the present invention has the effect of achieving improved hydraulic force use efficiency. Also, the water receiving plates can be arranged substantially perpendicular to the looped rail installation direction, and the present invention has the effect of reducing load on the pulleys by allowing hydraulic force to be applied in the looped rail installation direction, and consequently, enabling control of hydraulic force use efficiency.

It should be understood that the embodiments and the accompanying drawings as described above have been described for illustrative purposes and the present invention is limited by the following claims. Further, those skilled in the art will appreciate that various modifications, additions and substitutions are allowed without departing from the scope and spirit of the invention as set forth in the accompanying claims

1. A hydraulic power generating system comprising:
a looped rail fixedly mounted on a structure floating on the surface of water;
a plurality of pulleys installed to the looped rail;
a plurality of water receiving plates, each of which is installed to each of the pulleys; and
a plurality of connectors used to connect the respective neighboring pulleys with one another,
wherein the looped rail is installed such that an angle defined by a looped rail installation direction and a water flow direction is in a range of 10 to 45 degrees.

2. The hydraulic power generating system according to claim 1, wherein the water receiving plates, installed to the pulleys, have an installation angle within a predetermined range from a direction perpendicular to the water flow direction to a direction perpendicular to the looped-rail installation direction.
